(19) United States
(12) Patent Application Publication
(10) Pub. No.: US 2021/0032142 A1
(43) Pub. Date: Feb. 4, 2021

(54) WATER TREATMENT SYSTEM AND METHOD

(71) Applicant: Craig Ramsey, Fort Collins, CO (US)

(72) Inventor: Craig Ramsey, Fort Collins, CO (US)

(21) Appl. No.: 16/906,035

(22) Filed: Jun. 19, 2020

Related U.S. Application Data
(60) Provisional application No. 62/879,631, filed on Jul. 29, 2019.

(51) Int. Cl. C02F 9/00; B01F 3/04; B01F 5/04

(52) U.S. Cl. CPC C02F 9/00; B01F 3/0446; C02F 1/482; C02F 2305/023; B01F 5/0413

(57) ABSTRACT

A water treatment system includes a water passage, a magnet and a hydroxyl radical generator. Water flows through the water passage. The magnet is adjacent to the water passage and produces a magnetic field in the water passage, The hydroxyl radical generator generates hydroxyl radicals in the water in the water passage. A water treatment method includes the steps of providing a water passage, producing a magnetic field in the water passage, flowing water through the magnetic field and generating, while the water is in the magnetic field, hydroxyl radicals in the water. The water can be recirculated through the water passage a number of times.

### TECHNICAL FIELD

The present invention relates to a water treatment system and method, and more particularly to a system and method that create coherent domains in liquid water.

### BACKGROUND ART

Clusters of water molecules form as coherent domains in liquid water at ordinary temperatures and pressures through hydrogen bonds. Water is a mixture of molecules in these coherent domains and in non-coherent molecular phases, and there is a rapid interchange between the coherent domain and non-coherent molecular phases. The coherent domain phase of water is the less dense state with tetrahedral-directed fully hydrogen-bonded water molecules in the excited/energized state, while the non-coherent water molecules represent the dense state in which the hydrogen bonding is not so regular. Increasing the concentration of coherent domains in water provides benefits to plant and animal life.

Ultraviolet (UV) light rays can sterilize water by destroying 99.9% of protozoa, bacteria and even viruses. Injection of ozone into waste water promotes oxidation and degradation of organic compounds. Prior known water treatment systems have used the concurrent application of UV light and ozone to water. U.S. Pat. No. 4,141,830 discloses such a system. Such systems clean or purify the water, but do not alter the structure of the water.

Other prior known water treatment systems pass water through a magnetic field. U.S. Pat. No. 5,055,189 discloses a system for removal of dissolved ions, iron content, precipitates and colloids by passing the water through a magnetic field. U.S. Pat. No. 5,679,257 discloses a wastewater treatment system that, in separate stages, injects ozone into the water flow, then irradiates the water with UV light and then passes the water though a magnetic field. U.S. Pat. No. 7,718,059 discloses an apparatus for producing magnetized water. The apparatus is claimed to activate the water by reducing the coherent domains.

### DISCLOSURE OF THE INVENTION

A water treatment system includes an elongated water passage, a magnet and a hydroxyl radical generator. Water flows through the water passage. The magnet is adjacent to the water passage and produces a magnetic field in the water passage. The hydroxyl radical generator generates hydroxyl radicals in the water in the water passage. The system can also include a return line so that water can be recirculated through the water passage a plurality of times. A water treatment method includes the steps of providing a water passage, producing a magnetic field in the water passage, flowing water through the magnetic field and generating, while the water is in the magnetic field, hydroxyl radicals in the water.

### BRIEF DESCRIPTION OF THE DRAWINGS

Details of this invention are described in connection with the accompanying drawings that bear similar reference numerals in which:

FIG. 1 is a block diagram of a water treatment system embodying features of the present invention.

FIG. 2 is a side elevation view of the water passage, UV source and magnet of FIG. 1.

### DETAILED DESCRIPTION OF THE INVENTION

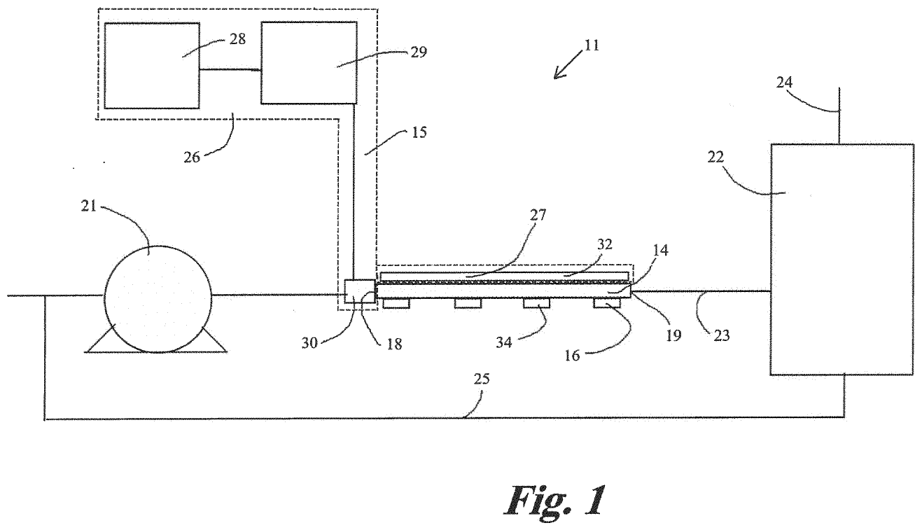

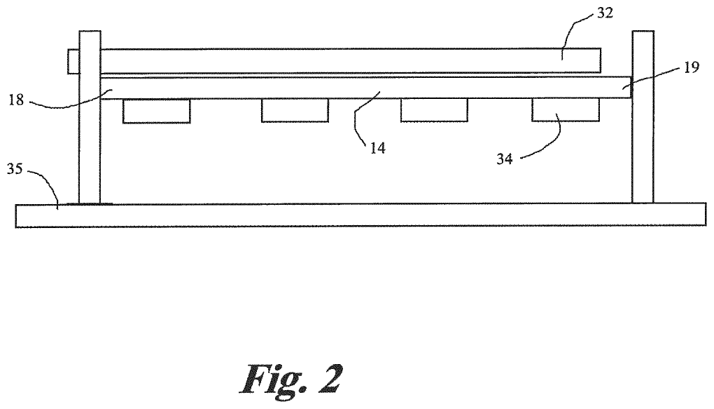

Referring to FIGS. 1 and 2, a water treatment system 11, embodying features of the present invention, includes an elongated water passage 14, a hydroxyl radical generator 15 and a magnet 16. The water passage 14 has an inlet 18 and a spaced outlet 19. A pump 21 is connected to the inlet 18 to pump water through the water passage 14 from the inlet 18 to the outlet 19. A tank 22 is connected by a tank water line 23 to the outlet 19 to receive the treated water. The tank 22 includes a tank outlet 24.

The system 11 shown is configured as a closed loop with the tank 22 connecting back to the pump 21 and includes a return water line 25 from the tank 22 back to the pump 21. The system 11 may also be configured to connect the outlet 19 directly to a point of use. The water passage 14 shown is a one inch diameter quartz tube that is forty inches long.

The hydroxyl radical generator 15 shown includes an ozone system 26 and a UV source 27. The ozone system 26 includes an oxygen concentrator 28, an ozone generator 29 and a venturi 30. The oxygen concentrator 28 connects to and supplies oxygen (O₂) to the ozone generator 29. The ozone generator 29 generates ozone (O₃) and connects to the venturi 30. The venturi 30 connects to the inlet 18 of the water passage 14. Water flowing through the venturi 30 draws ozone into the water.

The UV source 27 shown includes three one inch diameter UVC lamps 32 that are each forty inches long. The UVC lamps 32 are mounted on the water passage 14. The UVC lamps 32 irradiate the ozonated water in the water passage 14 to generate hydroxyl radicals.

Other methods and the appropriate accompanying apparatus can be used to generate hydroxyl radicals in the water in the water passage 14. By way of example, and not as a limitation, these methods include:
1. Hydrogen Peroxide/Ozone (H₂O₂/O₃))
2. Cavitation
3. Hydrogen Peroxide/Ultraviolet Irradiation (H₂O₂/UV)
4. High Energy Electron Beam Irradiation (E-beam)
5. TiO₂-catalyzed UV Oxidation
6. Fenton's Reaction

The magnet 16 mounts on the water passage 14, opposite the UVC lamps 32, and produces a magnetic field in the water passage 14. The magnet 15 shown includes a plurality of magnet portions 34 spaced along the water passage 14. The magnet portions 34 are preferably permanent magnets. The magnet portions 34 are preferably mounted with either all of the north poles or all of the south poles facing the water passage 14, and more preferably mounted with the south poles facing the water passage 14. Four magnet portions 34 are shown with each magnet portion 34 being a four inch by three inch by two inch neodymium magnets. The magnet 16 may include additional magnet portions 34 spaced along the tank water line 23 between the outlet 19 and the tank 22.

In FIG. 2, the water passage 14, UV source 27, and the magnet 16 are supported by a cradle 35. By way of example, the water flow rate can be about 49 liter per minute (LPM) and the ozone concentration at the inlet 18 can be about 20-28 parts per million (ppm). The magnet portions 34 can each have a magnetic field strength of about 540 milliTesla (mT) Water is recirculated through the water passage 14 ten to fifteen times to completely treat the water.

A water treatment method includes the steps of providing a water passage, producing a magnetic field in the water passage, flowing water through the magnetic field and generating, while the water is in the magnetic field, hydroxyl radicals in the water. The method may include the step of recirculating the water through the water passage while repeating the steps of producing and generating. The step of generating may include the substeps of ozonating the water, and after the substep of ozonating, irradiating the water with UVC light. The step of producing may include providing a plurality of magnet portions spaced along the water passage. The magnet portions can be permanent magnets and can be mounted with all of the south poles facing the water passage.

The water treatment system 11 generates a percentage of coherent domains in the bulk water that are aligned with the polarity (positive or negative) of the external magnetic fields. The coherent domains generated from the water treatment system 11 have subatomic particles (electrons or protons) aligned (either negative or positive spins) with the magnetic field polarity of the magnet 16.

The percentage of coherent domain structures generated by the water treatment system 11 is adjustable. The concentration of coherent domain structures is a function of ozone concentration in the water, length and intensity of the ultraviolet light source 27, and number and field strength of the magnet portions 34, along with water flow rate.

The water treated by the water treatment system 11 can trap and store electromagnetic energy from its environment. Coherent domain structures have an “electron outer shell” that can readily and rapidly trap and store unused energy from its environment. The unused, electromagnetic energy could be light or heat, or even cellular energy in the form of heat. This energy raises the “shell of electrons” to a higher orbit, which increases the electrical conductivity of the treated water and traps or stores that energy in bulk water. Electrical conductivity of the treated water can increase from about 1,600 to about 2,800 microsiemens per centimeter (μS/cm), by placing the water into direct sunlight over a couple of hours of exposure.

Although the present invention has been described with a certain degree of particularity, it is understood that the present disclosure has been made by way of example and that changes in details of structure may be made without departing from the spirit thereof.

What is claimed is:

1. A water treatment system comprising:
an elongated water passage having an inlet and a spaced outlet, with water flowing through said water passage from said inlet to said outlet,
a magnet adjacent to said water passage that produces a magnetic field having a polarity in said water passage, and
a hydroxyl radical generator that generates hydroxyl radicals in said water in said water passage,
whereby coherent domains that are aligned with said polarity are generated in said water.

2. The system as set forth in claim 1 including:
a pump connected to said inlet for pumping said water though said water passage, and
a return line connected from said outlet to said pump,
whereby said water can be recirculated through said water passage to increase said coherent domains in said water.

3. The system as set forth in claim 1 wherein:
said water passage is a quartz tube, and
said hydroxyl radical generator includes an ozone system connected to said inlet to ozonate said water and a UV source mounted on said water passage to irradiate said water.

4. The system as set forth in claim 3 wherein said ozone system includes an oxygen concentrator, an ozone generator connected to said oxygen concentrator, and a venturi connected to said ozone generator and to said inlet,
whereby water flowing through said venturi draws ozone into said water

5. The system as set forth in claim 1 wherein said magnet includes a plurality of magnet portions spaced along said water passage.

6. The system as set forth in claim 5 wherein said magnet portions are permanent magnets.

7. The system as set forth in claim 6 wherein said magnet portions are mounted with one of all north poles or all south poles facing said water passage.

8. The system as set forth in claim 6 wherein said magnet portions are mounted with all south poles facing said water passage.

9. A water treatment system comprising
an elongated water passage having an inlet and a spaced outlet, with water flowing through said water passage from said inlet to said outlet, said water passage being a quartz tube,
a magnet adjacent to said water passage that produces a magnetic field having a polarity in said water passage, said magnet including a plurality of magnet portions spaced along said water passage with all south poles facing said water passage,
a hydroxyl radical generator that generates hydroxyl radicals in said water in said water passage, said hydroxyl radical generator including an ozone system connected to said inlet to ozonate said water and a UV source mounted on said water passage to irradiate said water,
a pump connected to said inlet for pumping said water though said water passage, and
a return line connected from said outlet to said pump,
whereby coherent domains that are aligned with said polarity are generated in said water, and said water can be recirculated through said water passage to increase said coherent domains in said water.

10. A water treatment method comprising the steps of:
providing a water passage,
producing a magnetic field having a polarity in said water passage,
flowing water through said water passage and said magnetic field, and
generating, while said water is in said magnetic field, hydroxyl radicals in said water,
whereby coherent domains that are aligned with said polarity are generated in said water

11. The method as set forth in claim 10 including the step of recirculating said water through said water passage while repeating said steps of producing and generating.

12. The method as set forth in claim 10 wherein said step of generating includes the substeps of ozonating said water, and after said substep of ozonating, irradiating said water with UVC light.

13. The method as set forth in claim 10 wherein said step of producing includes providing a plurality of magnet portions spaced along said water passage.

14. The method as set forth in claim 13 wherein said magnet portions are permanent magnets.

15. The method as set forth in claim 14 wherein said magnet portions are mounted with all south poles facing said water passage.
